(19) United States
(12) Patent Application Publication
(10) Pub. No.: US 2013/0007606 A1
(43) Pub. Date: Jan. 3, 2013

(54) TEXT DELETION

(75) Inventor: Andre Moacyr DOLENC, Espoo (FI)

(73) Assignee: NOKIA CORPORATION, Espoo (FI)

(21) Appl. No.: 13/174,256

(22) Filed: Jun. 30, 2011

(51) Int. Cl. G06F 17/21

(52) U.S. Cl. 715/256

(57) ABSTRACT

A method, apparatus, and computer product for: receiving an indication of a first user input associated with a text input area containing text; identifying a syntactic block of the text; and in response to the reception of the indication of the first user input, deleting from the text input area only those characters of the text contained within the syntactic block.

### TECHNICAL FIELD

The present application relates generally to the deletion of text.

### BACKGROUND

Developments in information technology have increased the availability of many different new media for communication. However, they have also driven a renewed demand for textual content.

Not only have developments such as the World Wide Web and electronic books made it possible for amateur authors to publish their own written material, but levels of textual communication have exploded with the introduction of e-mail, Short Message Service (SMS) messaging, instant messaging, internet forums, and social network websites. The creation and consumption of textual content remains prolific, and is integral to modern life.

Computing devices and other apparatus commonly provide functionality for text-based user interaction. Such interactions may involve the creation or consumption of textual content, or may simply provide an interface to functionality offered via the apparatus (e.g. via a command line).

One of the actions that users commonly perform in relation to text is the deletion of characters.

### SUMMARY

A first example embodiment provides a method comprising: receiving an indication of a first user input associated with a text input area containing text; identifying a syntactic block of the text; and in response to the reception of the indication of the first user input, deleting from the text input area only those characters of the text contained within the syntactic block.

A second example embodiment provides apparatus comprising: a processor; and memory including computer program code, the memory and the computer program code configured to, working with the processor, cause the apparatus to perform at least the following: receive an indication of a first user input associated with a text input area containing text; identify a syntactic block of the text; in response to the reception of the indication of the first user input, delete from the text input area only those characters of the text contained within the syntactic block.

A third example embodiment provides a computer program product comprising a computer-readable medium bearing computer program code embodied therein for use with a computer, the computer program code comprising: code for receiving an indication of a first user input associated with a text input area containing text; code for identifying a syntactic block of the text; and code for deleting from the text input area, in response to the reception of the indication of the first user input, only those characters of the text contained within the syntactic block.

Also disclosed is apparatus configured to perform any of the methods described herein.

Also disclosed is apparatus comprising: means for receiving an indication of a first user input associated with a text input area containing text; means for identifying a syntactic block of the text; and means for deleting from the text, in response to the reception of the indication of the first user input, only those characters of the text contained within the syntactic block.

The means for receiving the first user input may be embodied in the form of a touchscreen, keyboard, mouse, or other user input hardware, and/or a controller that is configured to receive and interpret inputs from such hardware. Such controllers may include dedicated logic, for example an application specific integrated circuit, or a processor and computer program code for instructing the processor to receive and interpret the inputs.

The means for identifying means for identifying a syntactic block of the text may be similarly embodied in the form of dedicated logic (for example an application specific integrated circuit), or a processor and computer program code for instructing the processor to perform the identification. The means may include information relating to known syntaxes that has been stored in a memory.

The means for deleting from the text, in response to the reception of the indication of the first user input, only those characters of the text contained within the syntactic block may be similarly embodied in the form of dedicated logic (for example an application specific integrated circuit), or a processor and computer program code for instructing the processor to perform the deletion. The text may be stored in a memory, and the means may include components that are configured to modify the contents of the memory in order to effect the deletion.

### BRIEF DESCRIPTION OF THE DRAWINGS

For a more complete understanding of example embodiments of the present invention, reference is now made to the following descriptions taken in connection with the accompanying drawings in which:

FIG. 1 is an illustration of an apparatus according to an example embodiment;

FIG. 2 is an illustration of a device according to an example embodiment;

FIG. 3 is an illustration of a World Wide Web browser user interface according to an example embodiment;

FIGS. 4A-D are illustrations of an address bar according to an example embodiment;

FIGS. 5A-D are illustrations of an address bar according to example embodiment;

FIG. 6A-E are illustrations of an address bar according to example embodiment;

FIG. 7 is an illustration of an address bar according to example embodiment;

FIG. 8 is an illustration of an address bar according to example embodiment;

FIG. 9 is an illustration of an address bar according to example embodiment; and

FIG. 10 is a flow chart illustrating a method according to an example embodiment.

### DETAILED DESCRIPTION OF THE DRAWINGS

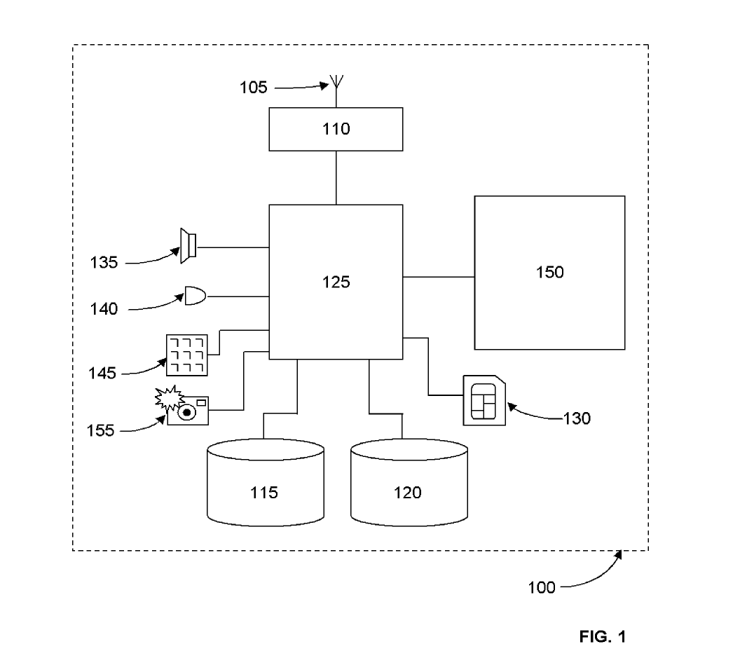

Example embodiments of the present invention and their potential advantages are understood by referring to FIGS. 1 through 10 of the drawings.

Within computing and more general devices, it is becoming commonplace to provide text input areas into which new text can be input by a user, and/or whose existing text can be edited by a user. Such devices may provide a keyboard through which the user can enter characters that will appear in the text box, or recognise text through another suitable means—for example using handwriting recognition. Sometimes it a means of deleting characters from such input areas is provided to the user to permit him to delete, for example, characters that he has entered erroneously, or characters that have been automatically added to the text input area by the device or applications running on it and that the user wishes to remove from it.

Several different approaches to deleting unwanted characters will now be presented by way of example.

In the first approach, the user performs a first input action that moves the focus of the user interface of the device to the text input area. For example, the user may make a selection of the text input area, whereupon a caret may be displayed at a position within the text input area to indicate a position within the text input area at which subsequent editing will be performed. The user may then perform a second input action to move the caret to a position immediately before or after a character that he wishes to delete. The user may then perform a third input action that instructs the device to delete the character immediately before or after (as appropriate) the caret's position, for example pressing a backspace or delete button on a hardware or virtual keyboard, or by making a particular touch gesture. The user may then repeat the second and third input actions as required for each character that he wishes to delete. The user may then perform a final input action to return the focus to the user interface element with which he was previously interacting before selecting the text input area. This exemplary approach may be time consuming and requires a large number of actions by the user. What is more, successful deletion may be very much dependent upon accurate placement of the caret by the user, and erroneous deletions caused by inaccurate caret placement can be laborious or impossible for the user to correct (particularly if he does not recall the identity of the character or characters he has erroneously deleted). This approach may also requires an area of the device to be given aside for a backspace key, or similar UI (User Interface) component, with which the user instructs the deletion of each character. If this UI component is a hardware component then it may add cost and complexity to the device's manufacture, if it is a virtual component then it may reduce the display area available for other purposes, and in either case it increases the complexity of the user interface by requiring the user to seek out the UI component and interact with it. A user may benefit from an approach which is less time consuming, requires fewer user actions, and is more accurate for the user to use. It may also be beneficial to minimise or even eliminate the area of the device to be given aside for a backspace key, or similar UI (User Interface) component, with which the user instructs the deletion of each character.

In a related alternative approach, the user can partially reduce the burden of repeatedly positioning the cursor and activating the backspace key (or similar) by using a special input action that allows more than one character to identified for simultaneous deletion. For example, the caret may be dragged between two positions in the text, highlighting the characters that appear between them. A single activation of the backspace key (or similar) may cause all these highlighted characters to be deleted at once. This approach may go some way to alleviating the burden of the repeated user actions, but the user may desire an approach that is even less time consuming, requires even fewer user actions, and is even more accurate for the user to use. It may also be beneficial to minimise or even eliminate the area of the device to be given aside for a backspace key, or similar UI (User Interface) component, with which the user instructs the deletion of each character.

In another approach, the user may use a stylus to draw a line through a portion of the text in the text input area. In response to this line drawing, the device causes the characters overlapped by the line to be deleted. Although this approach does not require the presence of a backspace key (or similar), it may still be highly reliant upon accurate user inputs. What is more, if the user misjudges the start and end point of the line, he may not have the opportunity to correct this mistake before the characters are deleted. The user may desire an approach that is even less time consuming, requires even fewer user actions, and is even more accurate for the user to use. It may also be beneficial to minimise or even eliminate the area of the device to be given aside for a backspace key, or similar UI (User Interface) component, with which the user instructs the deletion of each character.

In yet another approach, a dedicated UI component may be assigned to delete the entire contents of the text input area. For example, the text input area may have a virtual button associated with it whose function on activation is to clear the text input area by deleting the entirety of the text within it. However, this approach may require display area to be assigned to the special UI component that could otherwise be used for other purposes—e.g. displaying content to the user. What is more, it may not always be the case that the user wishes to delete the entirety of the text in the input area, and the special UI component is of no assistance when deleting only a subset of the characters. The user may desire an approach that is even less time consuming, requires even fewer user actions, and is even more accurate for the user to use. It may also be beneficial to minimise or even eliminate the area of the device to be given aside for a backspace key, or similar UI (User Interface) component, with which the user instructs the deletion of each character.

FIG. 1 illustrates an apparatus 100 according to an example embodiment. The apparatus 100 may comprise at least one antenna 105 that may be communicatively coupled to a transmitter and/or receiver component 110. The apparatus 100 may also comprise a volatile memory 115, such as volatile Random Access Memory (RAM) that may include a cache area for the temporary storage of data. The apparatus 100 may also comprise other memory, for example, non-volatile memory 120, which may be embedded and/or be removable. The non-volatile memory 120 may comprise an EEPROM, flash memory, or the like. The memories may store any of a number of pieces of information, and data—for example an operating system for controlling the device, application programs that can be run on the operating system, and user and/or system data. The apparatus may comprise a processor 125 that can use the stored information and data to implement one or more functions of the apparatus 100, such as the functions described hereinafter. In some example embodiments, the processor 125 and at least one of volatile 115 or non-volatile 120 memories may be present in the form of an Application Specific Integrated Circuit (ASIC), a Field Programmable Gate Array (FPGA), or any other application-specific component. Although the term “processor” is used in the singular, it may refer either to a singular processor (e.g. an FPGA or a single CPU), or an arrangement of more than one singular processor that cooperate to provide an overall processing function (e.g. two or more FPGAs or CPUs that operate in a parallel processing arrangement).

The apparatus 100 may comprise one or more User Identity Modules (UIMs) 130. Each UIM 130 may comprise a memory device having a built-in processor. Each UIM 130 may comprise, for example, a subscriber identity module, a universal integrated circuit card, a universal subscriber identity module, a removable user identity module, and/or the like. Each UIM 130 may store information elements related to a subscriber, an operator, a user account, and/or the like. For example, a UIM 130 may store subscriber information, message information, contact information, security information, program information, and/or the like.

The apparatus 100 may comprise a number of user interface devices, for example, a microphone 135 and an audio output device such as a speaker 140. The apparatus 100 may comprise one or more hardware controls, for example a plurality of keys laid out in a keypad 145. Such a keypad 145 may comprise numeric (for example, 0-9) keys, symbol keys (for example, #, *), alphabetic keys, and/or the like for operating the apparatus 100. For example, the keypad 145 may comprise a conventional QWERTY (or local equivalent) keypad arrangement. The keypad may instead comprise a different layout, such as E.161 standard mapping recommended by the Telecommunication Standardization Sector (ITU-T). The keypad 145 may also comprise one or more soft keys with associated functions that may change depending on the input of the device. In addition, or alternatively, the apparatus 100 may comprise an interface device such as a joystick, trackball, or other user input device.

The apparatus 100 may comprise one or more display devices such as a screen 150. The screen 150 may be a touchscreen, in which case it may be configured to receive input from a single point of contact, multiple points of contact, and/or the like. In such an example embodiment, the touchscreen may determine input based on position, motion, speed, contact area, and/or the like. Suitable touchscreens may involve those that employ resistive, capacitive, infrared, strain gauge, surface wave, optical imaging, dispersive signal technology, acoustic pulse recognition or other techniques, and to then provide signals indicative of the location and other parameters associated with the touch. A “touch” input may comprise any input that is detected by a touchscreen including touch events that involve actual physical contact and touch events that do not involve physical contact but that are otherwise detected by the touchscreen, such as a result of the proximity of the selection object to the touchscreen. The touchscreen may be controlled by the processor 125 to implement an on-screen keyboard.

In other examples, displays of other types may be used. For example, a projector may be used to project a display onto a surface such as a wall. In some further examples, the user may interact with the projected display, for example by touching projected user interface elements. Various technologies exist for implementing such an arrangement, for example by analysing video of the user interacting with the display in order to identify touches and related user inputs.

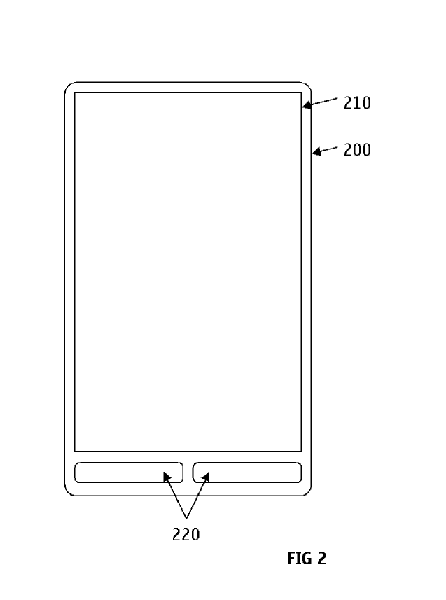

FIG. 2 illustrates a computing device 200 according to an example embodiment. FIG. 2 may comprise the apparatus 100 of FIG. 1. The device has a touch screen 210 and hardware buttons 220, although different hardware features may be present. For example, instead of a touchscreen 210 the device 200 may have a non-touch display upon which a cursor can be presented, the cursor being movable by the user according to inputs received from the hardware buttons 220, a trackball, a mouse, or any other suitable user interface device.

Non-exhaustive examples of other devices including apparatus, implementing methods, or running or storing computer program code according to example embodiments of the invention may include a mobile telephone or other mobile communication device, a personal digital assistant, a laptop computer, a tablet computer, a games console, a personal media player, an internet terminal, a jukebox, or any other computing device. Suitable apparatus may have all, some, or none of the features described above.

Example embodiments of the invention will be described with reference to the apparatus 100 and device 200 shown in FIGS. 1 and 2. However, it will be understood that the invention is not necessarily limited by the inclusion of all of the elements described in relation to the drawings, and that the scope of protection is instead defined by the claims.

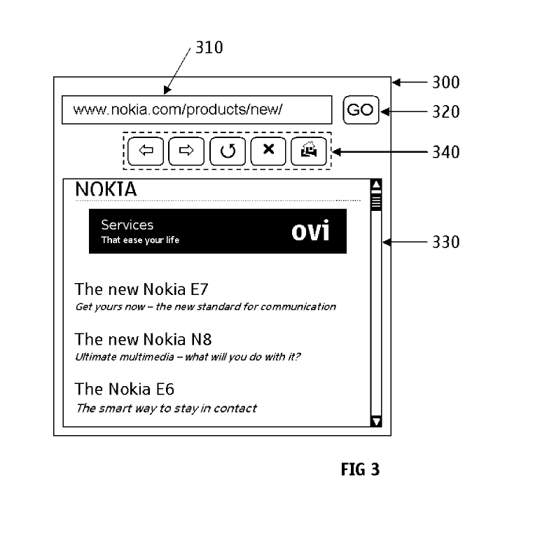

FIG. 3 shows an example of a UI 300 that might be displayed on the display of a device such as that 200 shown in FIG. 2. This particular UI is that of a World Wide Web (WWW) browser and includes a text input area 310, but the nature of the application and the particular UI are only examples. The application might be a text editor, a message client, a satellite navigation application, or any other application in which a text input area is included within the UI.

In the particular UI 300 of FIG. 3, the text input area 310 is an address bar, into which the user can input a Uniform Resource Locator (URL). A URL is an example of a Uniform Resorce Identifier (URI), and is used to identify a location on the internet, in this case the webpage located at “www.nokia.com/products/new”.

Also illustrated in FIG. 3 is a page area 330 in which the webpage located at “www.nokia.com/products/new” has been rendered for presentation to the user, and a toolbar area 340 in which UI components relating to the browser are presented to the user.

The URL shown in the address bar 310 of FIG. 3 is just one example. URLs typically include one or more elements of the following structure: “scheme://username:password@domain:port/path?query_string#fragment_id”. Here, “scheme” refers to the namespace, purpose, and syntax of the remaining part of the URL, for example the scheme name “HTTP” indicates that the remainder of the URL is to be processed according to the HyperText Transfer Protocol (i.e. as a web page). “username” and “password” define authentication information that are to be used when making connections to a destination location defined by the URL. The “domain” defines the destination location for the URL, and the “path” specifies a resource at the destination location. A path may include more than one level of structure, for example “level1/level2/level3”. The “port” defines a port at the destination location to which connections should be made. For example, the port number “80” is conventionally the default port for connections over HTTP. “query_string” represents data to be passed to software running at the destination location. Finally, “fragment_id” specifies a section or location within a web page defined by the URL. Not all of these elements need be present in a URL, and other elements may be present depending upon the scheme in use. The other characters present in the URL are used to delimit the different elements.

The URL present in the address bar 310 of UI 300 follows a particular syntax that is known to the browser. It is possible to break up the URL into blocks based on this knowledge. For example, the URL “www.nokia.com/products/new” might be broken up into the blocks www.nokia.com (domain), and “products/new” (path). This is not the only way to break apart the URL based upon its syntax, another example would be “www”, “nokia”, “com”, “products”, “new”. A suitable level of granularity for this division into blocks may be chosen depending on the use case.

There are many other examples where the knowledge of a text's syntax can be used to break it apart into blocks. For example, different types of URI follow different known syntaxes, and can be divided based upon such knowledge. Similarly, an e-mail address follows a known syntax and can be broken apart into component blocks (e.g. the e-mail address john.smith@nokia.com” can be broken apart into the elements “john.smith” and “nokia.com”; or “john”, “smith”, “nokia”, “com” depending on the required level of granularity. There exist many other syntaxes that can be used to divide strings of text into blocks.

For asyntaxe, blocks may be defined in a number of different ways, with the most appropriate definition (i.e. level of granularity) used. The choice of block definition may be a design choice that is made when software is written, or it may be configurable by the user, for example via a settings menu. Different choices may be more appropriate in different instances.

The term “syntax” is used herein to refer generally to a set of rules which define in some way which characters or groups of characters are to be interpreted within a body of text. For example, in the case of a conventional HTTP URL it is known from the syntax that the characters immediately following the symbol “#” define a fragment. It is similarly known that the characters immediately following the symbols “//:” define a domain and that the characters immediately following the rightmost “.” in this domain define the top level domain (e.g. “com”, “org” or “net”). These structural rules that define the format of a body of text are its “syntax”. It may be possible to break apart a body of text into individual syntactical elements at different levels of granularity depending on its syntax; a syntactic block is defined as a contiguous sequence of characters that can be identified using the syntax, but the granularity of this identification will vary according to the use case.

One type of text for which at least some syntax is well known is written language (linguistic text). Text written in a particular language (e.g. English, French, German, etc.) obeys a syntax specific to that language, to an appropriate dialect of that language. For example, knowledge of the syntax of the English language may be used to divide the phrase “I love sports, especially cricket.” into the sentence “I love sports, especially cricket”; the proposition “I love sports” and phrase “especially cricket”; the words “I”, “love”, “sports”, “especially”, and “cricket”; and so on. There are many different levels of granularity into which a passage of linguistic text can be broken into blocks based on its syntax, and the best choice of granularity will vary according to the use case. A “linguistic fragment” is defined as a sequence of characters making up a block according to the syntax of a language. The term “linguistic fragment” may include paragraphs, sentences, propositions, phrases, words, and other suitable syntactic units of a language.

It is possible to break text apart into blocks without a description of the exact syntax of the text. For example, the expression “Ino harsai 23; yua 452; uas” is written using a syntax that does not correspond to an available description. However, this expression can readily be broken down into the blocks “Ino harsai 23”, “yua 452”, and “uas” based on the observation that these parts of the expression are delimited by the character “;” and the knowledge that “;” is commonly used as a delimiting character, and similarly into the blocks “Ino”, “harsai”, “23”, “yua, “452”, and “uas” based on similar observation and knowledge regarding the space character. Furthermore, such division is possible even in the absence of such a priori observation—e.g. the expression “3681g2712g1231g131g21” might be broken down into the blocks “3681”, “2712”, “1231”, “131”, and “21” based on the observation that the frequent use of “g” (although not a common choice of delimiting character) amongst a different type of character (numerals) suggests that it might be used as a delimiter in this case.

A description of a syntax may be provided (e.g. stored in the memory of a device) that provides information regarding the syntax to allow it to be broken into syntactic blocks. For example, the description might include the identity of delimiting characters and other rules that can be used to identify and divide the blocks. The syntax applicable to a piece of text may be predefined (e.g. if when text is entered in a text input area that is pre-associated with a particular syntax, e.g. a browser address bar that is pre-associated with a URL syntax) or it may be determined on-the-fly by using an appropriate detection algorithm to recognise a particular syntax. Examples of such algorithms are used to determine the language (English, French, etc.) of a piece of text, and to identify particular syntaxes e.g. URLSs within larger bodies of text.

In such cases where a predefined syntax does not correspond to an available syntax description (or at least a corresponding available description cannot be identified), it is still possible to break apart text based on an assumed or guessed syntax based on observation of patterns in the text. When an approximate syntax is derived in such cases, the text may be broken apart into syntactic blocks using this approximate (or guessed) syntax.

Where a body of text is broken apart into syntactic blocks, it is possible to assign an order to such blocks. In a simple case, the order may merely be the order in which the blocks occur within the body of text, e.g. their occurrence from left to right within the text (i.e. from those that occur “early” in the text to those that occur “later” in the text). In a more complex example, a hierarchy might be defined for the blocks based on knowledge of the syntax. For example, suppose that the expression “oak_tree_plant” is divided into the blocks “oak”, “tree”, and “plant”. If it is known that the syntax used to compose this expression stipulates that the blocks become increasingly general to the right of the expression and increasingly specific towards its left, a hierarchy of the blocks can be defined. In increasing order of specificity the blocks read “plant”, “tree” and “oak”, and in increasing order of generality they read “oak”, “tree” and “plant”. This is just one example in which related blocks can be attributed a hierarchy based on the syntax used to identify them. Although not all syntaxes will allow a hierarchy to be determined, it will always be possible to order blocks in some manner, even if it is just the order of their occurrence within the body of text; however, an order or hierarchy need not actually be assigned to the blocks in every example.

Up until this point, delimiters (for example the spaces between words, or punctuation) have been ignored in the examples used to demonstrate the division of text into blocks. In some embodiments such delimiters may be ignored, but in others they are maintained either as part of their neighbouring identified blocks, or as blocks themselves. For example, the expression “Hello there, world!” might be divided into any word-wise into the blocks “Hello”, “there, and “world” ignoring the punctuation and spaces, or into any of the following if the spaces and punctuation are included as their own blocks or incorporated into neighbouring words:

“Hello”, “there,”, and “world!”
“Hello “, “there, “, and “world!”
“Hello” “ there,”, and “ world!”
“Hello”, “ “, “there”, “,”, “ “, and “world”, “!”

The above is not an exhaustive list—other divisions into blocks are also possible, even for this short example.

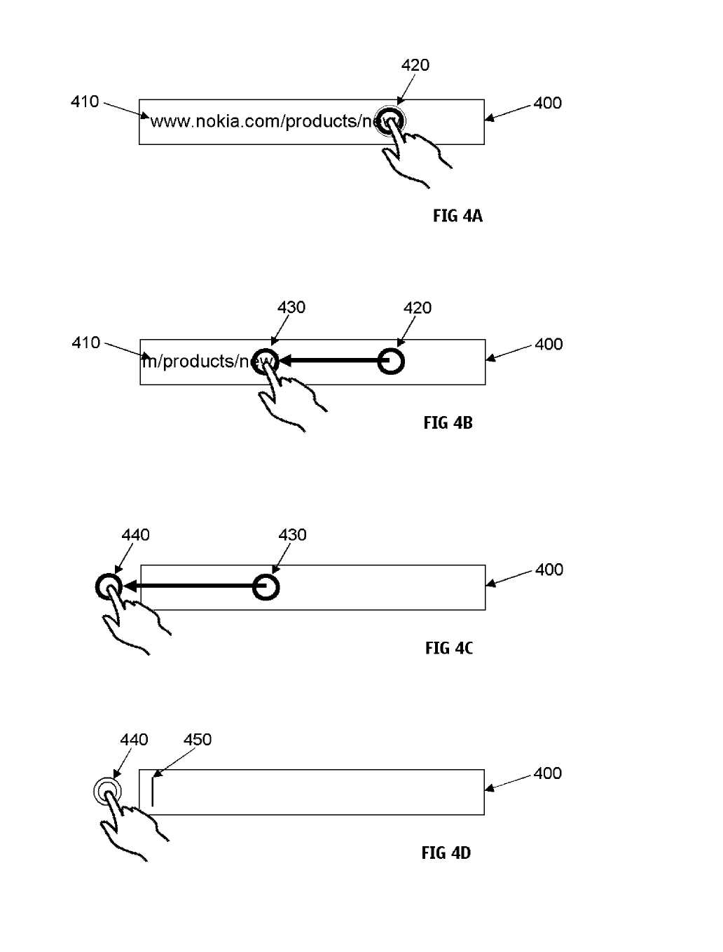

FIGS. 4A-D illustrate an example embodiment of a user interaction with a text input area 400 according to an example embodiment. In the example illustrated, the text area is an address bar 400, for example the address bar 310 of FIG. 3, but this is only one example of a suitable text input area.

In FIG. 4A the address bar 400 contains a body of text, a URL 410. The user has begun a touch gesture by putting his finger (or any other suitable stylus) down against the touch screen at point 420. In the example shown in FIGS. 4A-D, the touch gesture is associated with the text input area (the address bar 400) because it begins within the text area (i.e. point 420 lies inside the address bar 400), but associations based on other criteria are also possible. In some alternative examples, the association is made if the path of the completed touch gesture crosses the address bar 400, or terminates within the address bar 400, or the path of the touch gesture satisfies other criteria that have been predefined (e.g. according to a user setting, or manufacturer design) as associating the gesture with the text input area. In some examples, the gesture may necessarily begin outside the text input area and end within it, or vice versa.

In FIG. 4B the user has continued the touch gesture by swiping the touch from point 420 to 430. In response to this gesture, and to provide feedback to the user, the URL 410 displayed within the address bar 400 has been scrolled to the left as the touch gesture progresses, gradually removing the URL 410 from the visible area of the address bar 400. This or other feedback is not necessarily provided in all examples.

In FIG. 4C the user has continued to extend the touch gesture by swiping it to point 440, which lies outside the area of the address bar 400. The scrolling of the URL 410 has reached the extent that the URL has entirely left the visible area of the address bar.

In FIG. 4D the user has ended the touch gesture at point 440 by releasing the touch. In response, the text making up the entire URL 410 has been deleted from the address bar 400. In FIG. 4D a caret has been inserted into the address bar 400 in addition to the deletion—this has the result of moving the focus of the user interface to the address bar 400 in the expectation that having deleted the previous URL 410 the user is likely to immediately begin to enter a new URL. However, the insertion of the caret and change of focus are optional and need not be performed in all examples.

The scrolling effect applied to the URL 410 during the touch gesture provides feedback to the user, which in some examples can create the impression that the user's touch gesture is ‘sweeping’ the URL 410 out of the address bar 400. This feedback may not always be provided—in some embodiments no such feedback will be provided, and in others feedback may be provided differently, for example by fading the URL 410 as the touch gesture progresses, or by removing characters of the URL 410 one at a time during the touch gesture.

In the example shown in FIGS. 4A-D, the deletion of the text has been performed in response to a touch swipe gesture. However, other touch gestures may be used instead. For example, the deletion may be performed in response to a press and hold gesture on the address bar—in which case feedback on the operation may be provided by animation that is tied to the length of the press, for example, with the deletion confirmed by a hold that exceeds a predetermined duration.

In other embodiments, the touch gesture may be replaced by other types of user interaction. For example, a swiping or press and hold gesture may be performed by navigating a cursor to the address bar 400 using a mouse, joystick, directional-pad, trackpad, or other suitable input means, and pressing and holding a button down during the swipe or hold operation. The touch or cursor operation may be mapped to an area of the display outside the address bar, but associated with the address bar.

In other embodiments, entirely different user inputs may be used in place of either the touch or cursor-based input. For example, a particular physical key may be associated with the address bar 400 and pressing (or pressing and holding) the key may result in the deletion operation.

Returning to the example shown in FIG. 4A-D, different functionality may be provided in response to the termination of the gesture in different locations. For example, if the touch gesture is terminated inside the address bar 400 the deletion operation may be cancelled and any animated text returned to the address bar 400.

In another example, the deletion is dependent not only upon the gesture originating within the address bar 400 and extending outside it, but upon the gesture extending along a particular path, for example a path that is substantially right to left.

In some examples, the deletion is dependent not only upon the gesture originating within the address bar 400 and extending outside it, but instead on the gesture extending a minimum distance within the address bar 400, for example a minimum fixed distance through the address bar or a relative distance that is defined based on the distance between the origin of the gesture and an edge of the address bar 400. For example, if the gesture starts at a given point along the length address bar 400, the deletion may be dependent upon a swipe that extends leftwards by more than half of the distance between that given point and the leftmost edge of the address bar 400.

In the event that an animation representing the removal of the text, or a portion of it, from the address bar 400 has begun, but the gesture fails to complete according to criteria necessary for the deletion to take place, the animation may be reversed, or the text of the URL 410 otherwise returned to the address bar 400.

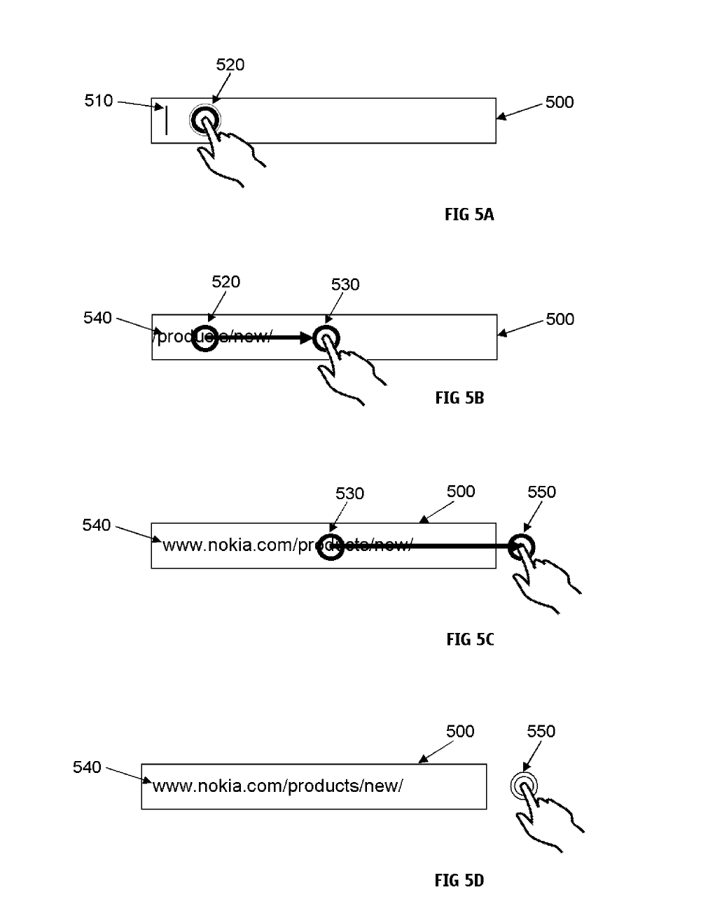

FIGS. 5A-5D illustrate the restoration of a previously deleted URL 540 to an address bar 500 according to an example embodiment. The URL 540 and address bar 500 may be those previously described in relation to FIGS. 4A-4D. Similarly to FIGS. 4A-4D, the concept illustrated in FIGS. 5A-5D is done so in terms of a touch swipe gesture applied to a URL 540 in an address bar 500, but it may be applied to any use case involving a body of text and a text input area, and the more general concept may be similarly applied to gestures and other user inputs other than a touch swipe.

The example of FIGS. 5A-5D begins at FIG. 5A, where a URL 540 has previously been deleted from an address bar 500. A caret 510 is illustrated in the address bar 500, but it may not be present, and the address bar 500 may not be in focus in the UI. The user has commenced a touch gesture by touching the address bar at point 520.

In FIG. 5B, the user has continued the touch gesture by swiping the touch from point 520 to 530. In response to this gesture, and to provide feedback to the user, the deleted URL 540 has been scrolled into the address bar 500 from the left as touch gesture progresses, gradually displaying the URL 410 into the visible area of the address bar 400.

In FIG. 5C the user has continued to extend the touch gesture by swiping it further right to point 550, which lies outside the area of the address bar 500. The scrolling of the URL 5400 has reached the extent that the URL has entered from the left the visible area of the address bar 500.

In FIG. 5D the user has ended the touch gesture at point 550 by releasing the touch. In response, the text making up the entire URL 540 has been restored to the address bar 500.

Similarly to FIGS. 4A-D, the scrolling effect applied to the URL 410 using the touch gesture provides feedback to the user, creating the impression that the user's touch gesture is ‘sweeping’ the URL 540 back into the address bar 500. This again is an optional feature—in some embodiments no such feedback will be provided, and in others feedback may be differently provided, for example by fading the URL 410 in as the touch gesture progresses, or by displaying characters of the URL 410 one at a time during the touch gesture.

In the example shown in FIGS. 5A-D, the restoration of the text of the URL 540 has been performed in response to a touch swipe gesture. However, other touch gestures may be used instead. For example, the restoration may be performed in response to a press and hold gesture on the address bar 500—in which case feedback on the operation may be provided by animation that is tied to the length of the press, for example, with the restoration confirmed by a hold that exceeds a predetermined duration.

The user inputs in response to which the deletion and subsequent restoration of one or more blocks are performed may be inputs that are selected to appear to the user to be opposite gestures. For example, where the deletion is associated with a right to left swipe gesture, the restoration may be associated with a right to left swipe gesture. The actual inputs themselves need not be exactly opposite (e.g. the swipes may not need to be exactly parallel, or of the exact same length)—it may be enough that they are merely substantially opposite.

In other embodiments, the touch gesture may be replaced by other types of user interaction. For example, a swiping or press and hold gesture may be performed by navigating a cursor to the address bar 500 using a mouse, joystick, directional-pad, trackpad, or other suitable input means, and pressing and holding a button down during the swipe or hold operation. The touch or cursor operation may be mapped to an area of the display outside the address bar 500, but associated with the address bar 500.

In other embodiments, entirely different user inputs may be used in place of either the touch or cursor-based input. For example, a particular physical key may be associated with the address bar 400 and pressing (or pressing and holding) the key may result in the restoration operation.

Returning to the example shown in FIG. 5A-D, different functionality may occur in response to the termination of the gesture in different locations. For example, if the touch gesture is terminated inside the address bar 500 the restoration operation may be cancelled and any animated text removed from the address bar 500.

In another example, the restoration is dependent not only upon the gesture originating within the address bar 500 and extending outside it, but upon the gesture extending along a particular path, for example a path that is substantially left to right.

In some examples, the restoration is dependent not only upon the gesture originating within the address bar 500 and extending outside it, but instead on the gesture extending a minimum distance within the address bar 500, for example a minimum fixed distance through the address bar or a relative distance that is defined based on the distance between the origin of the gesture and an edge of the address bar 500. For example, if the gesture starts at a given point along the length address bar 500, the restoration may be dependent upon a swipe that extends leftwards by more than half of the distance between that given point and the leftmost edge of the address bar 500.

In the event that an animation representing the return of the text, or a portion of it, from the address bar 500 has begun, but the gesture fails to complete according to criteria necessary for the restoration to take place, the animation may be reversed, or the text of the URL 510 otherwise removed from the address bar 500.

A scenario exists when the text in the address bar has been edited between the deletion of a URL and its attempted restoration. This scenario can be handled in a number of different ways, with the default handling either determined in the design stage (e.g. by a programmer) or via a user-accessible setting. In one approach, the ability to restore a URL is disabled if the text in the address bar has been edited since its deletion. In another approach the ability to restore the deleted URL is maintained, and any text present in the address bar immediately prior to the restoration is replaced by the restored URL. Again, this approach can be applied to the restoration of other types of text deleted from other types of text input area.

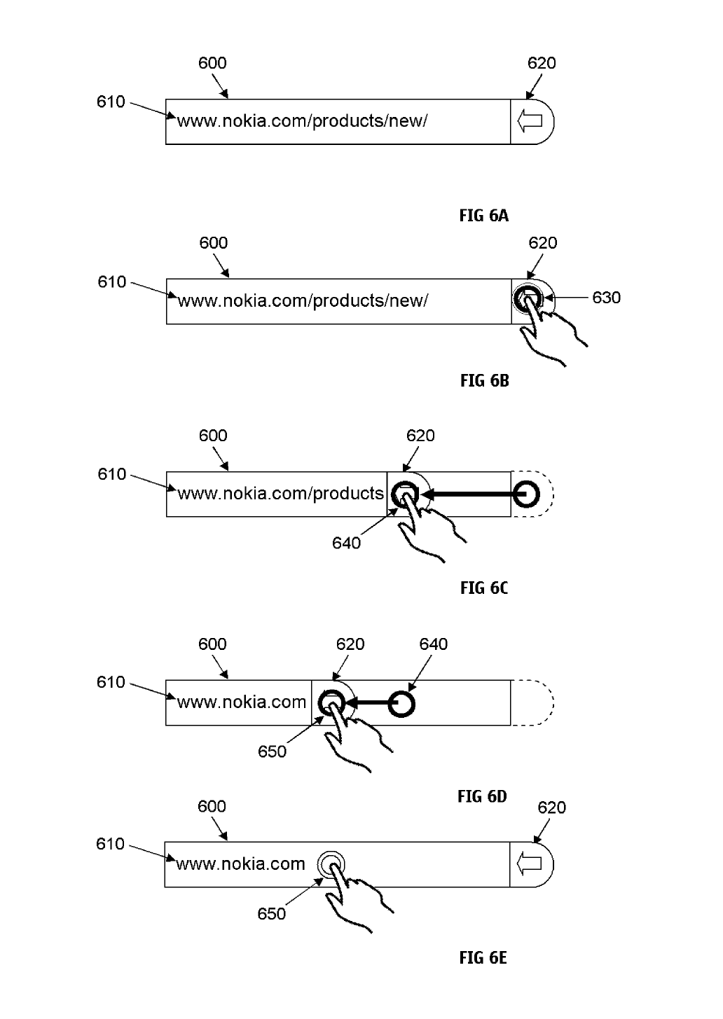

FIGS. 6A-E illustrate a number of different elements of functionality according to an example embodiment. For the sake of brevity these are described in the context of a single example; however, it is intended that they (like the other features disclosed in the context of examples) may be used in combinations other than those in which they appear in the drawings. Similarly, like FIGS. 4A-D and 5A-D, FIGS. 6A-E show an address bar 600 and a URL 610, but the disclosure is not limited to this specific example and the same concepts may be applied to any text input area containing text.

FIG. 6A illustrates an address bar 600 that contains a URL 610. Unlike the address bars of FIGS. 4A-D and 5A-D, the address bar 600 of FIG. 6A also includes a slider 620.

Slider 620 is so named because it can be slid by the user over the address bar, with the effect of deleting text contained within it. However, the slider 620 may have other functionality in response to other user interaction with it. For example, slider 620 may be a “GO” button, a press of which causes a browser to navigate to the URL 610 displayed in the address bar. The slider 620 may be a button having any function. The slider 620 may have alternative or additional other functionality that may or may not be related to the URL 610 (or to the text within the text input area).

In FIG. 6B the user has initiated a user input in relation to the slider 620. In the illustrated example, the user input is a touch drag that has been initiated by a touch at point 630, being a point on the slider. However, as with previous examples, other touch or non-touch user inputs may be used to control the user interface, including the slider.

In FIG. 6C the user has continued the user input by swiping the touch point from point 630 to point 640. This input has had the effect of translating the slider 620 from its original position to a new position partially along the length of the address bar 600. In FIG. 6C the new position of the slider 620 corresponds to point 640, and the slider 620 follows the location of the current touch point along the length of the address bar 600, but in other examples the displacement of the slider 620 may be otherwise scaled relative to the displacement of the touch point.

The division of a body of text into syntactic blocks has previously been discussed. The URL 610 of FIGS. 6A-E has been so-divided according to a level of granularity that divides the URL into blocks that represent the domain, and each element of the path that is delimited by an “/” symbol. This division is based on the syntax of a URL. Other levels of granularity could be employed, and in more general examples other syntaxes could be selected to better represent other text. The URL 620 in the present example has been divided into the blocks “www.nokia.com”, “/products”, and “/new”. The term “candidate block” is used to describe each of the blocks into which a body of text can be divided at a given level of granularity—“www.nokia.com”, “/products”, and “/new” are therefore the candidate blocks of the present example.

As the slider 620 is moved progressively across the address bar 600, successive candidate blocks are deleted from the URL 610 according to a predefined order. This order may (as has previously been described) be dependent upon the order in which the candidate blocks appear in the URL (e.g. from left to right), an order that is dependent upon a hierarchy, or any other suitable order. In the illustrated example, a hierarchical order is used, more specifically one in which the candidate blocks corresponding to the path elements are deleted in the order right to left, followed by the candidate block corresponding to the domain. This order allows the URL to be reduced by successive hierarchical levels as a series of deletions take place.

In response to the translation of the slider 620 to point 640, the first candidate block, corresponding the “\new” path element, is deleted from the URL 610. This is shown in FIG. 6C.

FIG. 6D shows a successive translation of the slider from point 640 to point 650, in response to which the second candidate block, corresponding to the “\products” path element, has also been deleted from the URL 610.

FIG. 6E illustrates the termination of the touch input at point 650. In response to the termination, the slider 620 is returned to its initial location. The remaining candidate blocks of the URL 610 (in this example, just the domain “www.nokia.com” is the only text that remains in the address bar 600.

In some embodiments, candidate blocks that have previously been deleted can be successively restored using a different user input, for example a drag of the slider 620 from left to right.

As has previously been mentioned, the use of a slider in the user input, and the successive deletion of syntactic blocks are separate concepts that need to be applied in combination. Other inputs, for example the swipe gestures described in relation to FIGS. 4A-D can be used to control the successive deletion of syntactic blocks. Similarly, the slider 620 can be applied to examples where the level of granularity dictates that the whole text is treated as a single syntactic block and deleted in one go.

FIGS. 6A-E illustrate an example where a slider 620 is located to the right of a text input area and is dragged to the left to delete syntactic blocks (regardless of whether text is divided into a single syntactic block or multiple syntactic blocks). However, other slider placements are also possible.

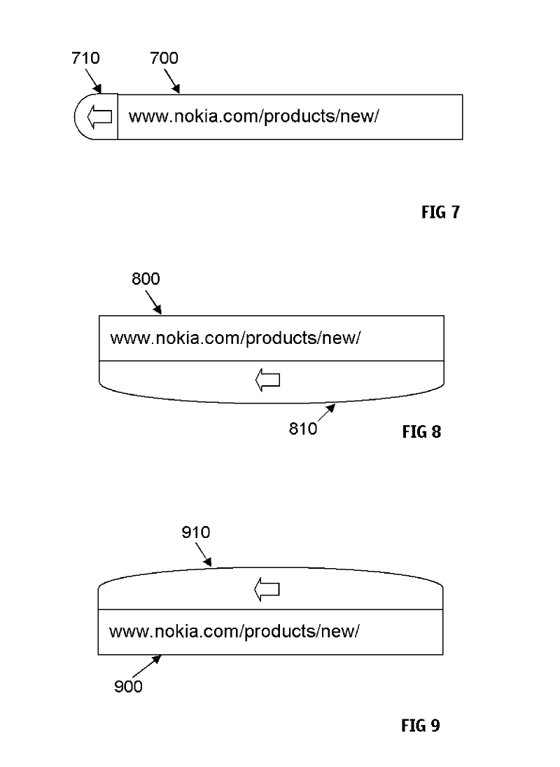

FIG. 7 illustrates an example embodiment where a slider 710 is located to the left of a text input area 700 and can be dragged right to delete syntactic blocks of text.

FIG. 8 illustrates an example embodiment where a slider 810 is located below a text input area 800 and can be dragged up to delete syntactic blocks of text.

FIG. 9 illustrates an example embodiment where a slider 910 is located to above of a text input area 700 and can be dragged down to delete syntactic blocks of text.

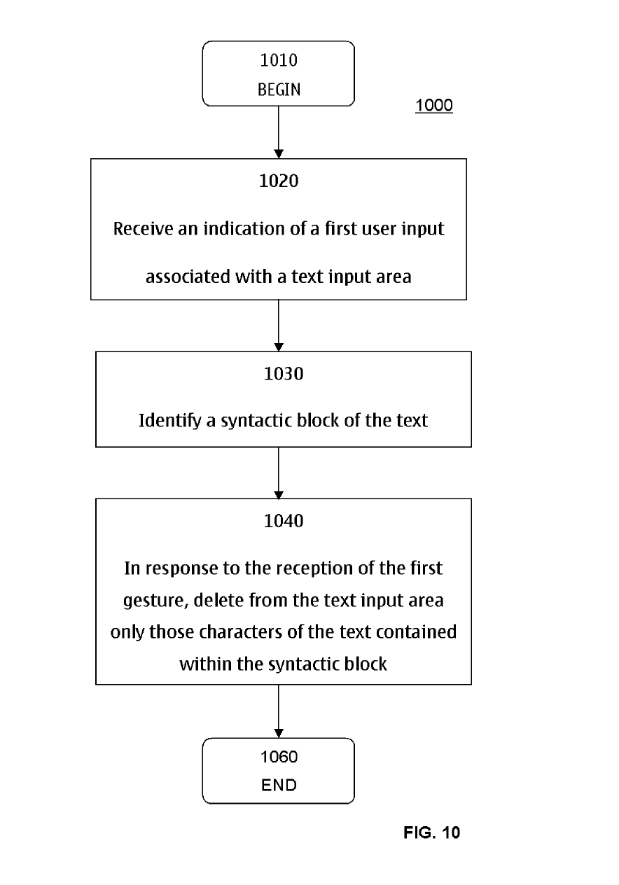

FIG. 10 provides an illustration of a method 1000 according to an example embodiment. The method begins at 1010. At 1020, a first user input is received, the first user input being associated with a text input area containing text. This user input may be a touch swipe gesture, or any other suitable gesture as previously described. At 1030 a syntactic block of the text is identified. Approaches to performing this identification have already been discussed. The identification may be performed in response to the reception of the first user input, or it may have previously been performed in advance of the reception. At 1040, and in response to the reception of the indication of the first user input, a deletion is made from the text of only those characters that are contained within the identified syntactic block. Finally, the method ends at 1050. This method may be adapted, in various further examples, to include any of the functionality described previously.

Without in any way limiting the scope, interpretation, or application of the claims appearing below, a technical effect of one or more of the example embodiments disclosed herein is that text can be deleted from a text input area quickly with minimal effort from the user, and with minimal complexity of the user interface and requirements regarding display area. Furthermore, one or more of the example embodiments are highly tolerant to inaccurate user inputs.

Example embodiments of the present invention may be implemented in software, hardware, application logic or a combination of software, hardware and application logic. The software, application logic and/or hardware may reside on a removable memory, within internal memory or on a communication server. In an example embodiment, the application logic, software or an instruction set is maintained on any one of various conventional computer-readable media. In the context of this document, a “computer-readable medium” may be any media or means that can contain, store, communicate, propagate or transport the instructions for use by or in connection with an instruction execution system, apparatus, or device, such as a computer, with examples of a computer described and depicted in FIG. 1. A computer-readable medium may comprise a computer-readable storage medium that may be any media or means that can contain or store the instructions for use by or in connection with an instruction execution system, apparatus, or device, such as a computer.

In some example embodiments, the invention may be implemented as an apparatus or device, for example a mobile communication device (e.g. a mobile telephone), a PDA, a computer or other computing device, or a video game console.

If desired, the different functions discussed herein may be performed in a different order and/or concurrently with each other. Furthermore, if desired, one or more of the above-described functions may be optional or may be combined.

Although various aspects of the invention are set out in the independent claims, other aspects of the invention comprise other combinations of features from the described example embodiments and/or the dependent claims with the features of the independent claims, and not solely the combinations explicitly set out in the claims.

It is also noted herein that while the above describes example embodiments of the invention, these descriptions should not be viewed in a limiting sense. Rather, there are several variations and modifications which may be made without departing from the scope of the present invention as defined in the appended claims. Furthermore, although particular combinations of features have been described in the context of specific examples, it should be understood that any of the described features may be present in any combination that falls within the scope of the claims.

1. A method comprising:
receiving a indication of a first user input associated with a text input area containing text;
identifying a syntactic block of the text; and
in response to the reception of the indication of the first user input, deleting from the text input area only those characters of the text contained within the syntactic block.

2. The method of claim 1, wherein identifying the syntactic block comprises:
identifying the entirety of the text as the syntactic block.

3. The method of claim 1, wherein identifying the syntactic block comprises:
identifying one or more candidate blocks of text, based on the determination that each block has a hierarchical level of syntax; and
identifying one or more of the candidate blocks as the syntactic block.

4. The method of claim 3, wherein the identified one or more of the candidate blocks are identified as the syntactic block based on the one or more candidate blocks having a lower hierarchical level of syntax than other candidate blocks.

5. The method of claim 3, wherein the text is a uniform resource identifier.

6. The method of claim 5, wherein:
the text input area is an address bar; and
the text is a uniform resource locator.

7. The method of claim 1, wherein identifying the syntactic block comprises:
identifying one or more candidate blocks of text, based on a determination that the candidate block is a linguistic fragment; and
identifying one or more of the candidate blocks as the syntactic block.

8. The method of claim 7, wherein the one or more of the candidate blocks are identified as the syntactic block based on the one or more of the candidate blocks occurring later in the text than other candidate blocks.

9. The method of claim 1, wherein the first predefined touch input is a touch input.

10. The method of claim 9, wherein the touch input is a touch swipe.

11. The method of claim 10, wherein deleting a character comprises animating the character in a direction that is based at least in part on direction of the swipe.

12. The method of claim 11, wherein speed of the animation is based at least in part upon speed of the swipe.

13. The method of claim 1, further comprising, after the deletion:
receiving a second user input associated with the text input area;
in response to the reception of the second user input, restoring the deleted characters to the text input area.

14. The method of claim 13, wherein:
the first user input is a touch swipe in a first direction;
the second user input is a touch swipe in a second direction; and
the second direction is substantially opposite to the first direction.

15. The method of claim 1 wherein the first user input comprises dragging a user interface component from a position exterior to the text input area, to a position interior to the first input area.

16. The method of claim 15, wherein the user interface component is a virtual button.

17. Apparatus comprising:
a processor; and
memory including computer program code,
the memory and the computer program code configured to, working with the processor, cause the apparatus to perform at least the following:
receive an indication of a first user input associated with a text input area containing text;
identify a syntactic block of the text; and
in response to the reception of the indication of the first user input, delete from the text input area only those characters of the text contained within the syntactic block.

18. The apparatus of claim 17, being a mobile telephone.

19. The apparatus of claim 17, being a tablet computing device.

20. A computer program product comprising a computer-readable medium bearing computer program code embodied therein for use with a computer, the computer program code comprising:
code for receiving an indication of a first user input associated with a text input area containing text;
code for identifying a syntactic block of the text; and
code for deleting from the text input area, in response to the reception of the indication of the first user input, only those characters of the text contained within the syntactic block.
